(19) United States
(12) Patent Application Publication
(10) Pub. No.: US 2023/0086066 A1
(43) Pub. Date: Mar. 23, 2023

(54) ACOUSTIC LUMINAIRE

(71) Applicant: Overwatch , LLC, Naperville, IL (US)

(72) Inventors: Scott Beu, Bolingbrook, IL (US); Ronaldo Santiago, South Elgin, IL (US)

(73) Assignee: Overwatch, LLC, Naperville, IL (US)

(21) Appl. No.: 17/948,744

(22) Filed: Sep. 20, 2022

Related U.S. Application Data
(60) Provisional application No. 63/246,021, filed on Sep. 20, 2021.

(51) Int. Cl. G10K 11/28; F21V 3/02; F21V 33/00; F21S 8/06

(52) U.S. Cl. CPC G10K 11/28; F21S 8/06; F21V 3/02; F21V 33/006

(57) ABSTRACT

A luminaire including an acoustic base,a lens in the acoustic base, and at least one light emitting device above the lens.

### BACKGROUND OF THE INVENTION

Ambient noise in buildings comes from a variety of sources including outside noise from traffic and interior noises from HVAC units, office noises and people distracts from productivity of office workers. These noises are amplified based on the materials used in the office space. Open ceilings present a unique challenge because there is no ceiling to absorb sound.

A need exists for a sound dampening lighting solution to remove ambient noise.

### SUMMARY OF THE INVENTION

Systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

One embodiment of the present disclose may include a luminaire including an acoustic base, a lens in the acoustic base, and at least one light emitting device above the lens.

In another embodiment, the lens is surrounded by the acoustic base.

Another embodiment includes a parabolic shaped cover attached to the acoustic base above the lens.

Another embodiment includes a securing unit attached to an end of the parabolic shape cover opposite the lens.

In another embodiment, the lens is aligned with a center line of the acoustic base.

In another embodiment, the lens is separated from at least one edge of the luminaire by the acoustic base.

In another embodiment, the at least one light emitting unit is positioned on the acoustic base on opposing sides of the lens.

In another embodiment, the at least one light emitting unit is positioned inside the parabolic cover.

In another embodiment, the parabolic cover has a reflective material on the surface of the parabolic cover facing the lens.

In another embodiment, the at least one light emitting unit is positioned such that light from the light emitting unit is reflected off the parabolic cover towards the lens.

Another embodiment of the present disclosure may include a method of suppressing noise using a luminaire including forming an acoustic base, forming a lens in the acoustic base, and positioning at least one light emitting device above the lens.

In another embodiment, the lens is surrounded by the acoustic base.

Another embodiment includes the step of attaching a parabolic shaped cover to the acoustic base above the lens.

Another embodiment includes the step of attaching a securing unit to an end of the parabolic shape cover opposite the lens.

In another embodiment, the lens is aligned with a center line of the acoustic base.

In another embodiment, the lens is separated from at least one edge of the luminaire by the acoustic base.

Another embodiment includes the step of positioning the at least one light emitting unit on the acoustic base on opposing sides of the lens.

In another embodiment, the at least one light emitting unit is positioned inside the parabolic cover.

In another embodiment, the parabolic cover has a reflective material on the surface of the parabolic cover facing the lens.

In another embodiment, the at least one light emitting unit is positioned such that light from the light emitting unit is reflected off the parabolic cover towards the lens.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1A depicts a perspective view of an acoustic luminaire;

FIG. 1B depicts a cut away view of the acoustic luminaire;

FIG. 1C depicts a bottom view of the luminaire;

FIG. 2A depicts a perspective view of an acoustic luminaire;

FIG. 2B depicts a side view of the luminaire;

FIG. 2C depicts a second side view of the luminaire;

FIG. 2D depicts a cut away view of the acoustic luminaire;

FIG. 3A depicts a perspective view of an acoustic luminaire;

FIG. 3B depicts a cut away view of the luminaire;

FIG. 3C depicts a top view of the luminaire;

FIG. 3D depicts a bottom view of the luminaire; and

FIG. 4 depicts a schematic representation of a process to manufacture the luminaire.

### DETAILED DESCRIPTION OF THE INVENTION

Referring now to the drawings which depict different embodiments consistent with the present invention, wherever possible, the same reference numbers will be used throughout the drawings and the following description to refer to the same or like parts.

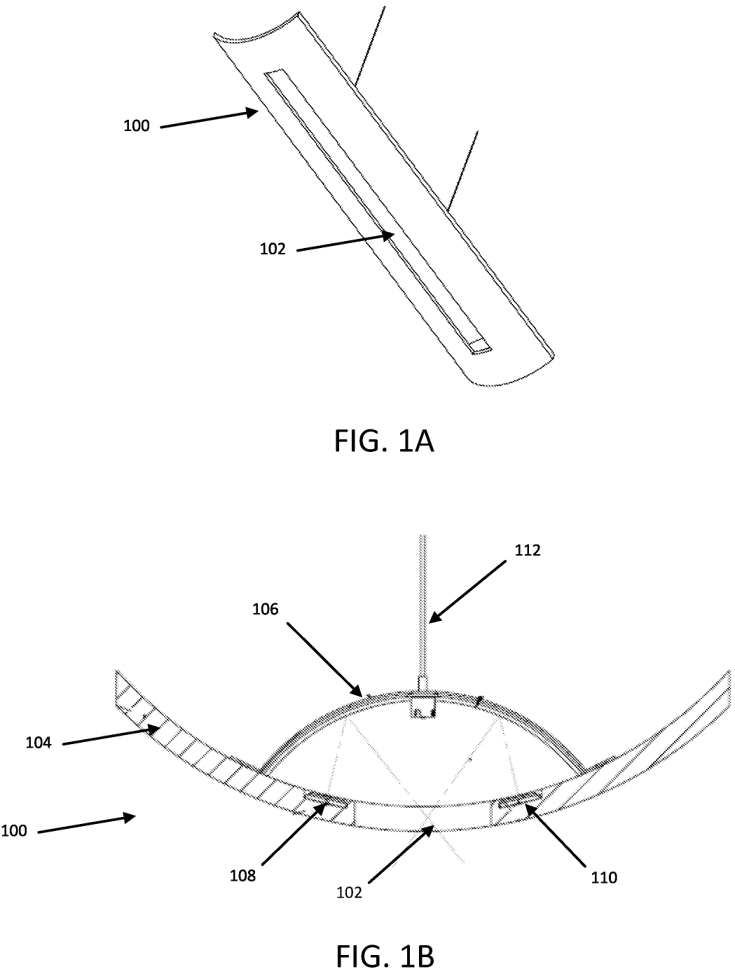

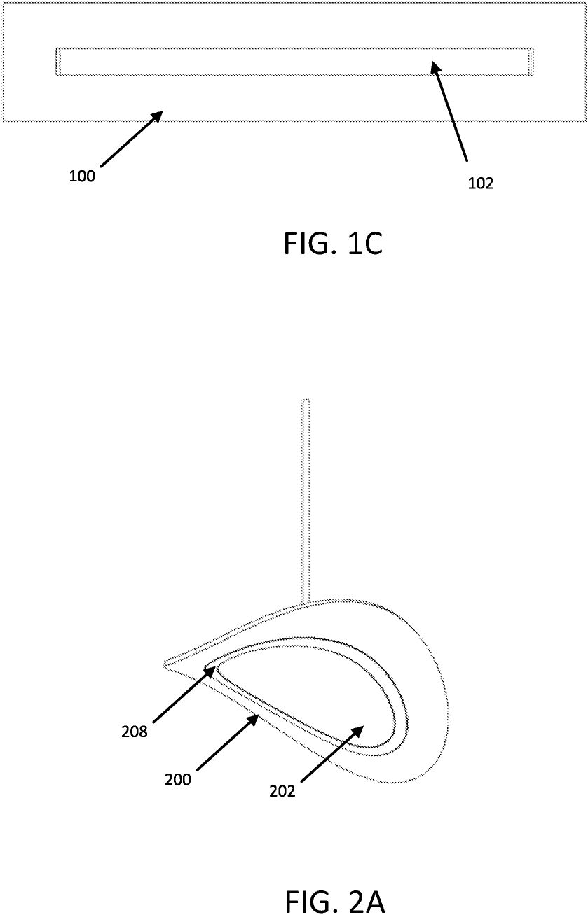

FIG. 1A depicts a perspective view of an acoustic luminaire. The acoustic luminaire 100 includes a light reflector 102 positioned in a central portion of the acoustic luminaire 100. FIG. 1B depicts a cut away view of the acoustic luminaire 100. The luminaire 100 includes acoustic material 104 separated by the light reflector 102. Light emitting devices 108 and 110 are positioned on a surface of the acoustic material facing the light reflector 102, which is contained within a parabolic cover 106. A securing unit 112 attaches to the parabolic cover 106 to attach the acoustic luminaire 100 to a structure. FIG. 1C depicts a bottom view of the luminaire 100 showing the light reflector 102 positioned along a centerline of the luminaire 100 with the light reflector 102 being separated from the edges of the luminaire by acoustic material.

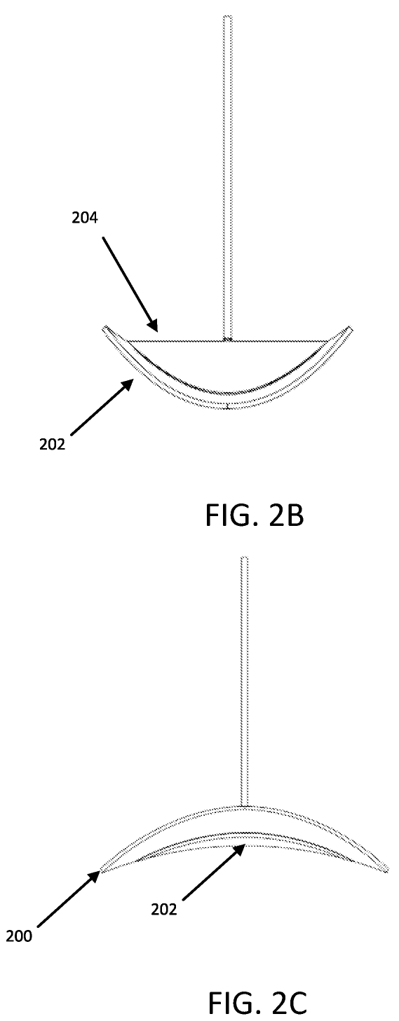

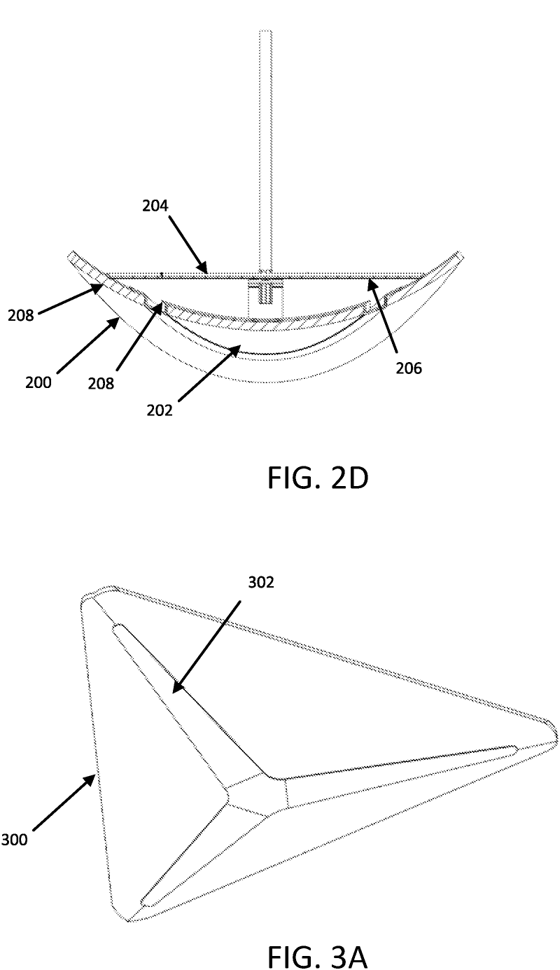

FIG. 2A depicts a perspective view of an acoustic luminaire 200. The acoustic luminaire includes a light cover 202. FIG. 2B depicts a side view of the luminaire 200. A support unit 204 extends across a diameter of the luminaire 100 connecting two opposite sides of the luminaire 200. FIG. 2C depicts a second side view of the luminaire 200 showing the curvature of the luminaire 200 and light cover 202. FIG. 2D depicts a cut away view of the luminaire 200. The luminaire 200 includes a strip of light emitting devices 206 positioned on a side of the support unit 204 facing the luminaire 200. The base of the luminaire 200 includes acoustic material 208 and the light cover 202. The light emitting devices 206 are arranged such that light shines through the lens 208.

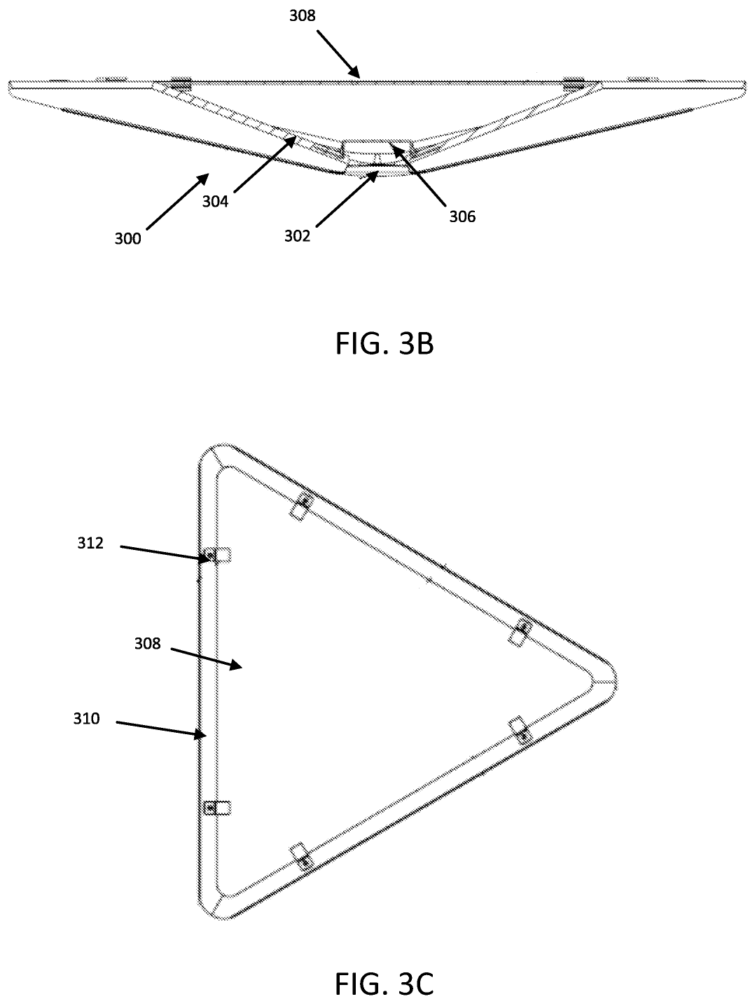

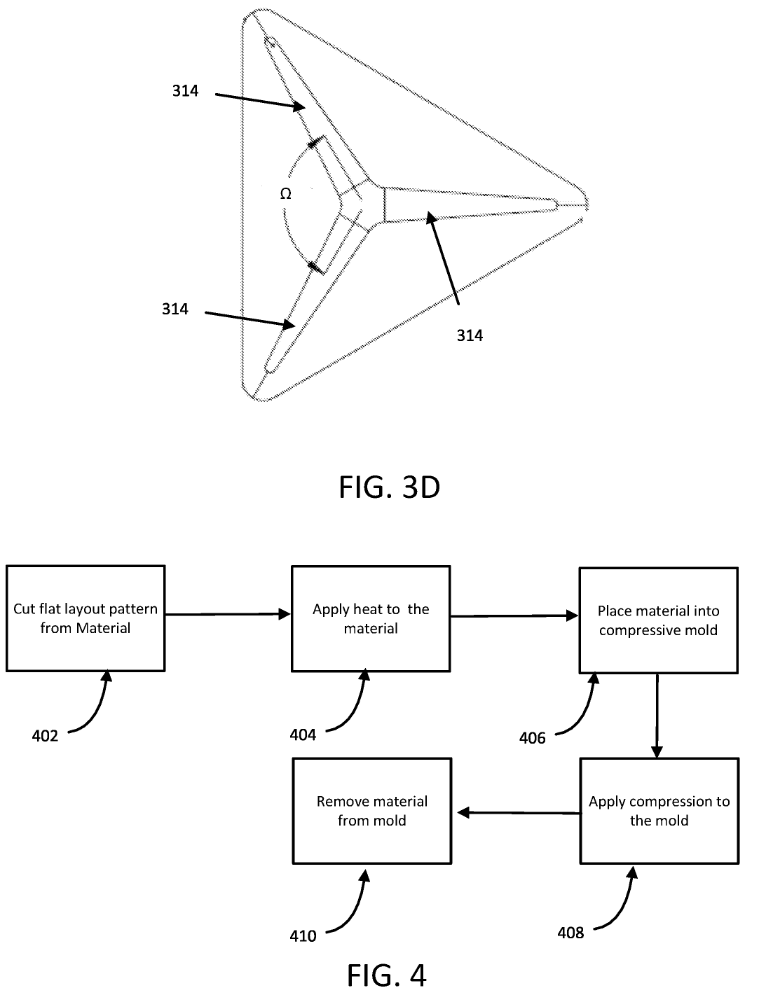

FIG. 3A depicts a perspective view of an acoustic luminaire 300. The luminaire 300 includes a lens 302. FIG. 3B depicts a cut away view of the luminaire 300. The luminaire 300 includes acoustic material 304 that surrounds the edges of the lens 302. A light emitting device 306 is positioned along the length of the lens 302. A cover unit 308 is secured to an end of the luminaire 300 opposite the lens 302. FIG. 3C depicts a top view of the luminaire 300. The cover unit 308 is secured to the edge 310 of the luminaire 300 by securing units 312. In one embodiment, the securing units 310 are movable to allow the cover unit 308 to be removed. FIG. 3D depicts a bottom view of the luminaire 300. The lens 302 includes a plurality of extension units 314 that are each separated by an angle Ω. In one embodiment, the angle Ω is the same value. In another embodiment, the angle Ω is one hundred and twenty degrees. In another embodiment, the angle between each extension 314 is different.

FIG. 4 depicts a process of manufacture a luminaire. In step 402, a flat layout pattern is cut form a piece of material. The pattern is sized such that the material can shrink and stretch. In one embodiment, the material is an acoustic dampening material. In step 404, heat is applied to the material. In one embodiment, heat is applied to the top and bottom of the material. In another embodiment, heat is applied to the top or the bottom of the material. The temperature of the heat applied ranges from 285° F. to 325° F. and is based on the size and shape of the material. In step 406, after a predetermined time of heating, the material is placed into a compression mold. The predetermined time is based on the size and shape of the material. In one embodiment the predetermined time is between 7 and 10 minutes. The material is allowed to cool while being in the compression mold. In step 408, the material is removed from the mold.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed:

1. A luminaire including:
an acoustic base;
a lens in the acoustic base; and
at least one light emitting device above the lens.

2. The luminaire of claim 1 wherein the lens is surrounded by the acoustic base.

3. The luminaire of claim 1 including a parabolic shaped cover attached to the acoustic base above the lens.

4. The luminaire of claim 3 including a securing unit attached to an end of the parabolic shape cover opposite the lens.

5. The luminaire of claim 1 wherein the lens is aligned with a center line of the acoustic base.

6. The luminaire of claim 1 wherein the lens is separated from at least one edge of the luminaire by the acoustic base.

7. The luminaire of claim 3 wherein the at least one light emitting unit is positioned on the acoustic base on opposing sides of the lens.

8. The luminaire of claim 7 wherein the at least one light emitting unit is positioned inside the parabolic cover.

9. The luminaire of claim 8 wherein the parabolic cover has a reflective material on the surface of the parabolic cover facing the lens.

10. The luminaire of claim 9 wherein the at least one light emitting unit is positioned such that light from the light emitting unit is reflected off the parabolic cover towards the lens.

11. A method of suppressing noise using a luminaire including:
forming an acoustic base;
forming a lens in the acoustic base; and
positioning at least one light emitting device above the lens.

12. The method of claim 11 wherein the lens is surrounded by the acoustic base.

13. The method of claim 11 including the step of attaching a parabolic shaped cover to the acoustic base above the lens.

14. The method of claim 13 including the step of attaching a securing unit to an end of the parabolic shape cover opposite the lens.

15. The method of claim 11 wherein the lens is aligned with a center line of the acoustic base.

16. The method of claim 11 wherein the lens is separated from at least one edge of the luminaire by the acoustic base.

17. The method of claim 13 including the step of positioning the at least one light emitting unit on the acoustic base on opposing sides of the lens.

18. The method of claim 17 wherein the at least one light emitting unit is positioned inside the parabolic cover.

19. The method of claim 18 wherein the parabolic cover has a reflective material on the surface of the parabolic cover facing the lens.

20. The method of claim 19 wherein the at least one light emitting unit is positioned such that light from the light emitting unit is reflected off the parabolic cover towards the lens.
